(19) United States
(12) Patent Application Publication
(10) Pub. No.: US 2025/0385745 A1
(43) Pub. Date: Dec. 18, 2025

(54) CORRECTION OF LOCAL CLOCK FOR MACHINE CONTROL WITH A REDUCED FREQUENCY OF SYNCHRONIZATION WITH A TIME MASTER

(71) Applicant: KABUSHIKI KAISHA YASKAWA DENKI, Kitakyushu-shi (JP)

(72) Inventors: Kazutoshi KOBAYASHI, Fukuoka (JP); Ryota MORIWAKA, Fukuoka (JP); Tadasuke YUBA, Fukuoka (JP); Yuki MINAMIDA, Fukuoka (JP); Ryo SHIMODOME, Fukuoka (JP); Mikio MATAKA, Fukuoka (JP); Kazuo FUJINO, Fukuoka (JP)

(21) Appl. No.: 19/315,658

(22) Filed: Sep. 1, 2025

Related U.S. Application Data
(63) Continuation of application No. PCT/JP2023/008906, filed on Mar. 8, 2023.

(51) Int. Cl. H04J 3/06

(52) U.S. Cl. CPC H04J 3/0682; H04J 3/0617

(57) ABSTRACT

A control system includes: a time master configured to periodically transmit synchronization signals for time synchronization via a network; and circuitry connected to the time master via the network, wherein the circuitry includes a local clock and is configured to: periodically determine, for every two or more receptions of the synchronization signal via the network, a communication timing so that a frequency of the communication timing is reduced from a transmission frequency of the synchronization signal; periodically perform, in accordance with the communication timing periodically determined with the reduced frequency, data exchange with the time master including transmission of a response signal to the synchronization signal; acquire an offset of the local clock with respect to the time master based on a result of the data exchange; correct the local clock in accordance with the offset; and control a machine based on the corrected local clock.

### CROSS-REFERENCE TO RELATED APPLICATIONS

This application is a continuation application of PCT Application No. PCT/JP2023/008906, filed on Mar. 8, 2023. The entire contents of the above listed PCT and priority applications are incorporated herein by reference.

### BACKGROUND

### Field

The present disclosure relates to a control system, a communication terminal, and a communication method.

### Description of the Related Art

Japanese Unexamined Patent Publication No. 2019-209454 discloses a system including a robot, a processing device, a robot controller that controls the robot, a processing device controller that controls the processing device, and a programmable logic controller that generates commands for the robot controller and the processing device controller.

### SUMMARY

Disclosed herein is a control system. The control system may include: a time master configured to periodically transmit synchronization signals for time synchronization via a network; and circuitry connected to the time master via the network. The circuitry may include a local clock and may be configured to: periodically determine, for every two or more receptions of the synchronization signal via the network, a communication timing so that a frequency of the communication timing is reduced from a transmission frequency of the synchronization signal; periodically perform, in accordance with the communication timing periodically determined with the reduced frequency, data exchange with the time master including transmission of a response signal to the synchronization signal; acquire an offset of the local clock with respect to the time master based on a result of the data exchange; correct the local clock in accordance with the offset; and control a machine based on the corrected local clock.

Additionally, a communication terminal communicable with a time master via a network and communicable with control circuitry is disclosed herein. The time master may be configured to periodically transmit a synchronization signal for time synchronization via the network. The control circuitry may include a local clock and may be configured to: receive the synchronization signal via the communication terminal; transmit, in response to receiving the synchronization signal, a response signal to the communication terminal for a data exchange; acquire an offset of the local clock based on a result of the data exchange; and correct the local clock in accordance with the offset. The communication terminal may be configured to: periodically determine, for every two or more receptions of the synchronization signal via the network, a communication timing so that a frequency of the communication timing is reduced from a transmission frequency of the synchronization signal; receive the response signal from the control circuitry; transmit, to the time master, the received response signal that corresponds to the determined communication timing so that the data exchange is performed; block the response signal that does not correspond to the communication timing, thereby preventing completion of the data exchange.

Additionally, a communication method is disclosed herein. The method may include: receiving a synchronization signal periodically transmitted from a time master via a network; periodically determining, for every two or more receptions of the synchronization signal via the network, a communication timing so that a frequency of the communication timing is reduced from a transmission frequency of the synchronization signal; periodically performing, in accordance with the communication timing periodically determined with the reduced frequency, data exchange with the time master including transmission of a response signal to the synchronization signal; acquiring an offset of a local clock with respect to the time master based on a result of the data exchange; correcting the local clock in accordance with the offset.

### BRIEF DESCRIPTION OF THE DRAWINGS

FIG. 1 is a schematic diagram illustrating an example machine system including a control system.

FIG. 2 is a schematic diagram illustrating an example configuration of a robot.

FIG. 3 is a block diagram illustrating an example functional configuration of the control system.

FIG. 4 is a block diagram illustrating an example configuration for performing time synchronization in the control system.

FIG. 5 is a sequence chart illustrating an example time synchronization sequence of a host clock.

FIG. 6 is a sequence chart illustrating an example time synchronization sequence of a local clock.

FIG. 7 is a block diagram illustrating a modification of the configuration for performing time synchronization.

FIG. 8 is a sequence chart illustrating a modification of the time synchronization sequence of the local clock.

FIG. 9 is a block diagram illustrating an example hardware configuration of the control system.

FIG. 10 is a block diagram illustrating an example hardware configuration of the control system.

FIG. 11 is a flowchart illustrating an example time synchronization procedure for the host clock.

FIG. 12 is a flowchart illustrating an example time synchronization procedure for the local clock.

FIG. 13 is a flowchart illustrating an example limiting procedure for the first correction process.

FIG. 14 is a flowchart illustrating a modification of the time synchronization procedure for the local clock.

FIG. 15 is a flowchart illustrating a modification of the time synchronization procedure for the local clock.

FIG. 16 is a flowchart illustrating a further modification of the time synchronization procedure for the local clock.

FIG. 17 is a flowchart illustrating an example procedure for changing the transmission frequency of the synchronization signal.

FIG. 18 is a flowchart illustrating an example host control procedure.

FIG. 19 is a flowchart illustrating an example local control procedure.

### DETAILED DESCRIPTION

In the following description, with reference to the drawings, the same reference numbers are assigned to the same components or to similar components having the same function, and overlapping description is omitted.

### [System]

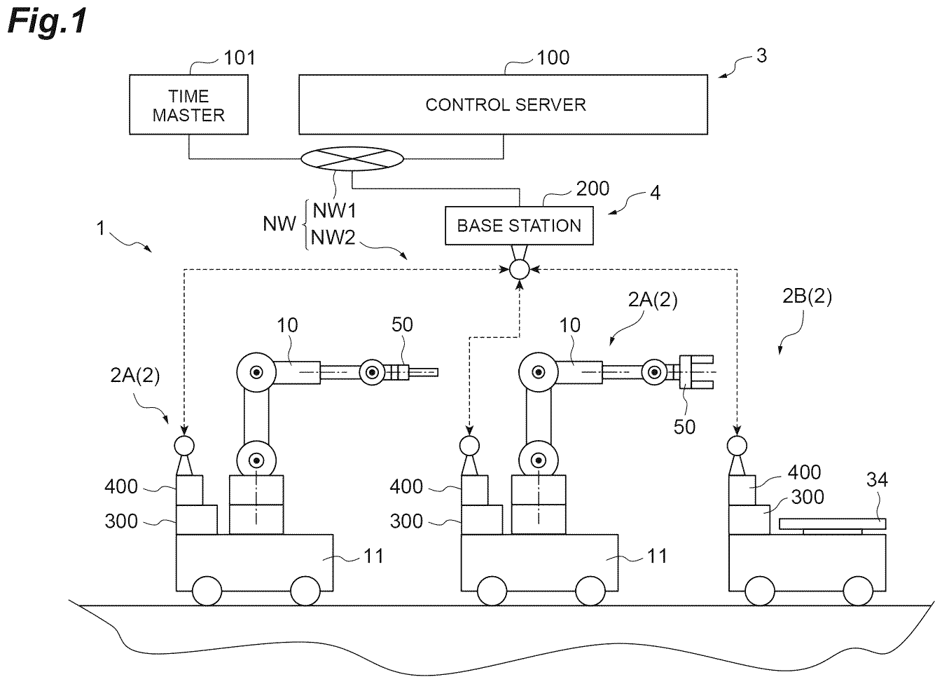

The machine system 1 illustrated in FIG. 1 is a system including a plurality of machines 2. An example of the machine system 1 is a production system that produces products through the cooperation of the plurality of machines 2. The machine system 1 includes the plurality of machines 2 and a control system 3.

### (Machine)

The plurality of machines 2 perform processing steps on one or more workpieces to produce products. A workpiece is a tangible object handled by each of the plurality of machines 2 to constitute at least a part of a product. For example, the workpiece may be a part to be assembled into a product, an intermediate product configured by assembling parts or the like, or the finally completed product itself.

The plurality of machines 2 include a robot. The plurality of machines 2 may further include machines other than robots. Examples of machines other than robots include a transfer device that transfers a workpiece, a device that adjusts the position and orientation of a workpiece to be worked on by a robot, and a machine tool that performs processing on a workpiece, but are not limited to these examples. Any machines, regardless of their structure, are included in the plurality of machines 2 as long as they can execute at least a part of the processing steps.

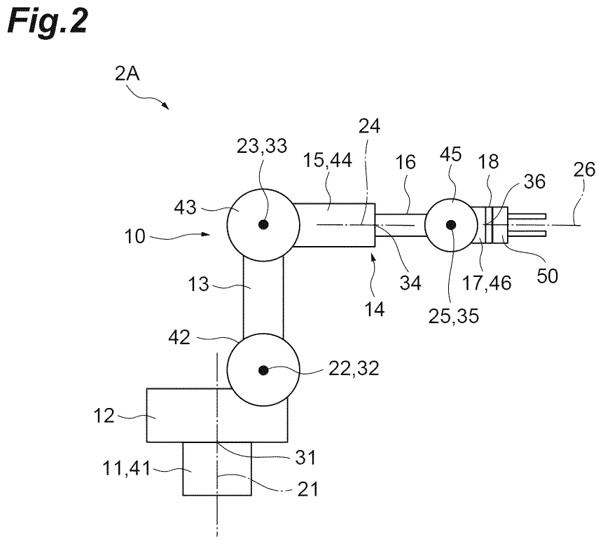

In the example of FIG. 1, the plurality of machines 2 include two robots 2A and a transfer device 2B. The robot 2A is a vertical articulated robot and, as illustrated in FIG. 2, has an articulated arm 10 and an end effector 50. The end effector 50 acts on a workpiece. Examples of the end effector 50 include a hand for gripping a workpiece or the like, a suction nozzle for sucking a workpiece, a welding torch for welding a workpiece, or a screw fastening tool for fastening a screw to a workpiece.

The articulated arm 10 is connected to the end effector 50 and changes the position and orientation of the end effector 50 by motion of multiple joints. For example, the articulated arm 10 has a base 11, a rotation part 12, a first arm 13, a second arm 14, a swing part 15, a third arm 17, a distal end 18, and actuators 41, 42, 43, 44, 45, and 46. The rotation part 12 is provided on the base 11 so as to rotate around a vertical axis 21. The first arm 13 is connected to the rotation part 12 so as to swing around an axis 22 that intersects (for example, is orthogonal to) the axis 21. Intersection also includes cases where there is a skewed relationship, such as a so-called three-dimensional intersection. The second arm 14 is connected to the distal end of the first arm 13 so as to swing around an axis 23 substantially parallel to the axis 22. The second arm 14 includes a swing part 15 and a rotation part 16. The swing part 15 is connected to the distal end of the first arm 13 and extends along an axis 24 that intersects (for example, is orthogonal to) the axis 23. The rotation part 16 is connected to the distal end of the swing part 15 so as to rotate around the axis 24 and extends further along the axis 24. The third arm 17 is connected to the distal end of the rotation part 16 so as to swing around an axis 25 that intersects (for example, is orthogonal to) the axis 24. The distal end 18 is connected to the distal end of the third arm 17 so as to rotate around an axis 26 that intersects (for example, is orthogonal to) the axis 25. A work tool such as a hand, a suction nozzle, or a welding torch is attached to the distal end 18.

Thus, the articulated arm 10 has a joint 31 connecting the base 11 and the rotation part 12, a joint 32 connecting the rotation part 12 and the first arm 13, a joint 33 connecting the first arm 13 and the second arm 14, a joint 34 connecting the swing part 15 and the rotation part 16 in the second arm 14, a joint 35 connecting the rotation part 16 and the third arm 17, and a joint 36 connecting the third arm 17 and the distal end 18.

The actuators 41, 42, 43, 44, 45, and 46 include, for example, electric motors and reduction gears, and drive the joints 31, 32, 33, 34, 35, and 36, respectively. For example, the actuator 41 rotates the rotation part 12 around the axis 21, the actuator 42 swings the first arm 13 around the axis 22, the actuator 43 swings the second arm 14 around the axis 23, the actuator 44 rotates the rotation part 16 around the axis 24, the actuator 45 swings the third arm 17 around the axis 25, and the actuator 46 rotates the distal end 18 around the axis 26.

The configuration of the articulated arm 10 can be modified. For example, the articulated arm 10 may be a 7-axis redundant robot with one more axis added to the 6-axis configuration described above, or may be a so-called SCARA-type articulated robot.

As illustrated in FIG. 1, the base 11 of the robot 2A may be capable of autonomous travel. An example of the self-propelled base 11 is an electrically-powered automated guided vehicle (AGV).

The transfer device 2B is a device that transfers a workpiece. The transfer device 2B is, for example, an electric automated guided vehicle.

### (Control System)

The control system 3 controls the plurality of machines 2. The control system 3 includes a control server 100 and a plurality of local controllers 300. Each local controller 300 communicates with the control server 100 via a network NW and controls the machine 2 in cooperation with the control server 100.

For example, each local controller 300 performs communication with the control server 100 via a communication system 4. The communication system 4 constitutes a non-periodic network between the control server 100 and the plurality of local controllers 300. For example, the communication system 4 constitutes a wireless communication network based on the 5th generation mobile communication system (5G).

For example, the communication system 4 includes a base station device 200 and a plurality of communication terminals 400 which are mobile stations. The base station device 200 communicates with the control server 100 via a wired communication network NW1 and constitutes a wireless communication network NW2 with the plurality of communication terminals 400. The plurality of communication terminals 400 communicate with the plurality of local controllers 300 via wired communication, respectively. With the above configuration, a network NW including the wired communication network NW1 and the wireless communication network NW2 is constituted between the plurality of controllers 110 and the plurality of local controllers 300.

Through communication via the communication system 4, the local controller 300 and the control server 100 repeat one set of control processing including acquisition of feedback data from the machine 2, generation of command data based on the feedback data, and control of the machine 2 based on the command data, at a predetermined control cycle. The control server 100 receives the feedback data from the local controller 300 via the communication system 4, generates the command data based on the feedback data, and transmits the command data to the local controller 300 via the communication system 4. The local controller 300 receives the command data from the control server 100 via the communication system 4, controls the machine 2 based on the command data, acquires the feedback data from the machine 2, and transmits the feedback data to the control server 100 via the communication system 4. In this way, the control server 100 and the local controller 300 exchange control data (the feedback data and the command data) via the communication system 4. In order to repeat the control processing at a periodic interval, the exchange of the control data may be performed by periodic communication.

In order to perform periodic communication with the control server 100, the local controller 300 exchanges control data with a designation of a periodic timing with the control server 100, and controls the machine 2 using the control data at the designated timing.

For example, the local controller 300 adds feedback timing information designating a periodic timing to the feedback data acquired from the machine 2 and transmits it to the control server 100. The control server 100 uses the feedback data at the timing designated by the feedback timing information to generate command data for the machine 2, adds command timing information designating a periodic timing to the generated command data, and transmits the command data to the local controller 300. Hereinafter, the timing designated by the feedback timing information is referred to as “feedback timing”. The local controller 300 controls the machine 2 using the command data at the timing designated by the command timing information and acquires feedback data from the machine 2. Hereinafter, the timing designated by the command timing information is referred to as “command timing”. By repeating the above procedure, the control server 100 and the local controller 300 use the feedback data and the command data at periodic timings, respectively. If the feedback timing is considered to be the substantial reception timing of the feedback data and the command timing is considered to be the substantial reception timing of the command data, it means that the exchange of the feedback data and the command data is substantially performed by periodic communication.

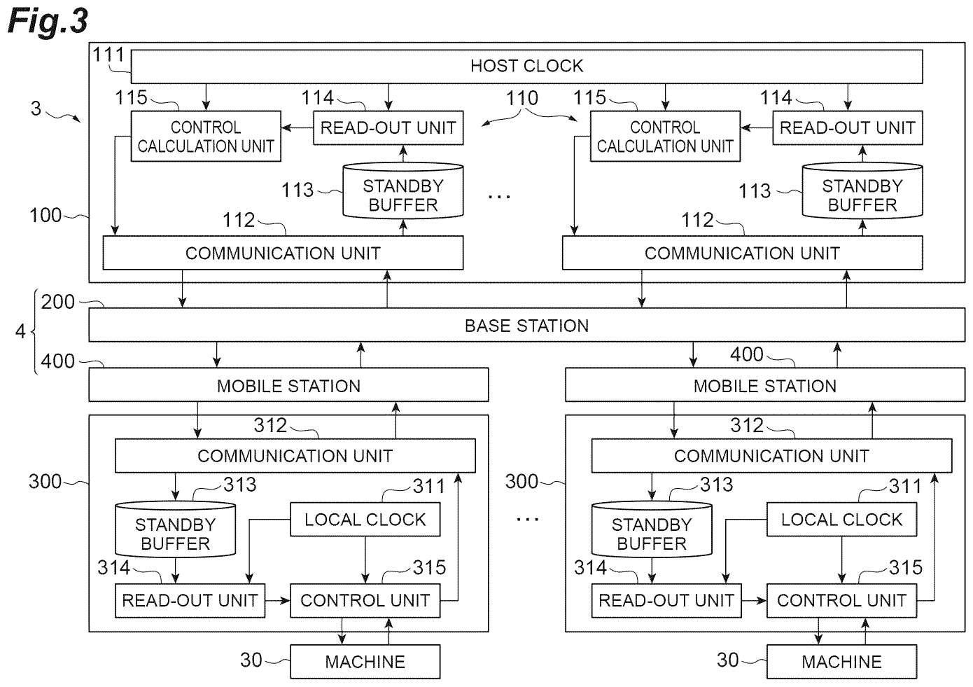

As illustrated in FIG. 3, the control server 100 includes, as a functional configuration, a host clock 111 and a plurality of controllers 110. Each of the plurality of controllers 110 includes a communication unit 112, a standby buffer 113, a read-out unit 114, and a control calculation unit 115. The host clock 111 generates a host time. For example, the host clock 111 counts clock pulses and generates the host time based on the count result and the period of the clock pulses.

The communication unit 112 exchanges, with the local controller 300, control data having a designation of a periodic timing for periodic communication via the non-periodic network NW. For example, the communication unit 112 receives the feedback data to which the feedback timing information is added from the base station device 200 and stores the feedback data in the standby buffer 113.

The read-out unit 114 reads out the feedback data from the standby buffer 113 at the feedback timing based on the host time and the feedback timing information.

The control calculation unit 115 generates command data using the feedback data at the feedback timing designated by the feedback timing information, based on the host clock 111. For example, the control calculation unit 115 generates the command data based on the feedback data read out by the read-out unit 114. For example, the control calculation unit 115 performs a proportional operation, a proportional-integral operation, or a proportional-integral-derivative operation on a deviation between a target operation and the operation of the machine 2 represented by the feedback data to calculate command data representing a target output (for example, target torque or target current). The control calculation unit 115 adds the command timing information to the generated command data. The control calculation unit 115 causes the communication unit 112 to transmit the command data to which the command timing information is added to the base station device 200. The command data transmitted by the communication unit 112 is transmitted to the communication terminal 400 by the base station device 200.

The local controller 300 includes, as a functional configuration, a local clock 311, a communication unit 312, a standby buffer 313, a read-out unit 314, and a control unit 315. The local clock 311 generates a local time synchronized with the host time. For example, the local clock 311 counts clock pulses and generates the local time based on the count result and the period of the clock pulses.

The communication unit 312 exchanges, with the controller 110, control data having a designation of a periodic timing for periodic communication via the non-periodic network NW. For example, the communication unit 312 receives the command data to which the command timing information is added from the communication terminal 400 and stores the command data in the standby buffer 313.

The read-out unit 314 reads out the command data from the standby buffer 313 at the command timing based on the local time and the command timing information.

The control unit 315 controls the machine 2 using the command data at the timing designated by the command timing information, based on the local clock 311. For example, the control unit 315 controls the machine 2 based on the command data read out by the read-out unit 314. For example, the control unit 315 controls the machine 2 with an output corresponding to the target output, and acquires feedback data representing the operation result of the machine 2 from the machine 2. The control unit 315 adds the feedback timing information to the acquired feedback data. The control unit 315 causes the communication unit 312 to transmit the feedback data to which the feedback timing information is added to the communication terminal 400. The feedback data transmitted by the communication unit 312 is transmitted to the base station device 200 by the communication terminal 400.

According to the example configuration described above, there may be variations in the delay time from the transmission of the feedback data by the local controller 300 to the reception of the feedback data by the controller 110. Even if there are variations in the delay time, the read-out of the received feedback data is performed at the timing determined by the feedback timing information. Therefore, the read-out of the feedback data can be executed in synchronization with the control cycle without being affected by the variations in the delay time.

Further, there may be variations in the delay time from the transmission of the command data by the controller 110 to the reception of the command data by the local controller 300. Even if there are variations in the delay time, the read-out of the received command data is performed at the timing determined by the command timing information. Therefore, the read-out of the command data can be executed in synchronization with the control cycle without being affected by the variations in the delay time.

Therefore, the exchange of control data between the controller 110 and the local controller 300 is substantially performed by periodic communication. In order to continue the periodic communication, a synchronization between the host clock 111 and the local clock 311 (synchronization between the host time and the local time) may be maintained.

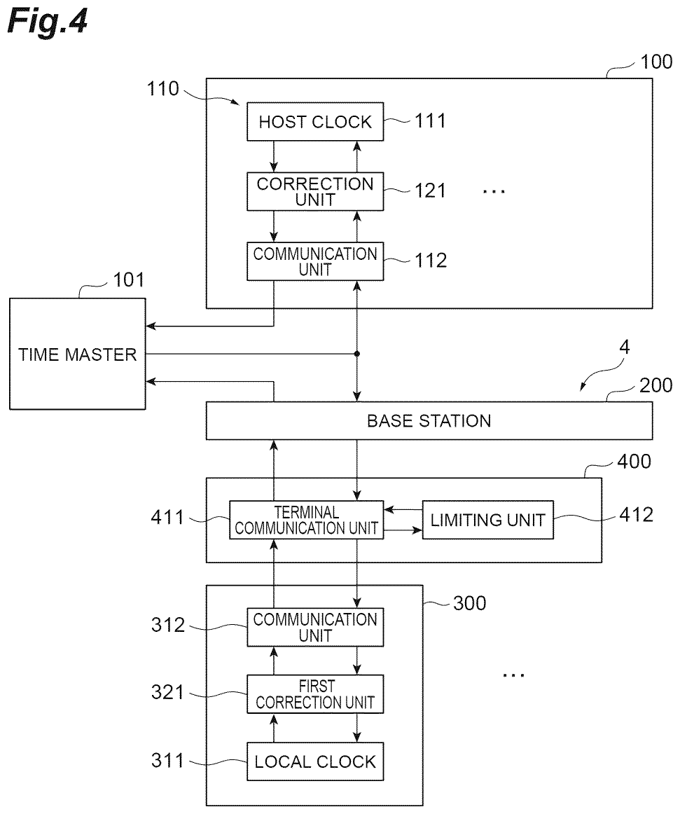

As illustrated in FIG. 4, the control system 3 further includes a time master 101 to maintain synchronization between the host clock 111 and the local clock 311. The time master 101 generates a reference time. The control server 100 and the local controller 300 are connected with the time master 101 via the network NW. For example, the control server 100 can communicate with the time master 101 via the wired communication network NW1, and the local controller 300 can communicate with the time master 101 via the wired communication network NW1 and the wireless communication network NW2.

The time master 101 is, for example, a grandmaster that generates a reference time by communicating with a GNSS (Global Navigation Satellite System). The time master 101 may be a network switch having a function as a boundary clock.

The time master 101 periodically transmits a synchronization signal for performing time synchronization with respect to the reference time via the network NW. The time master 101 may be configured to transmit transmission time information of the synchronization signal, represented by the reference time, included in the synchronization signal. The time master 101 may be configured to transmit the transmission time information subsequent to the synchronization signal, without including the transmission time information in the synchronization signal itself. Further, the time master 101 may be configured to, upon receiving a response signal to the synchronization signal, further transmit reception time information of the response signal and transmission time information of the reception time information. The time master 101 may transmit the reception time information and the transmission time information simultaneously or separately.

The controller 110 further includes a correction unit 121. The correction unit 121 corrects the host clock 111 (host time) to be synchronized with the time master 101 (reference time). For example, the correction unit 121 corrects the host clock 111 to be synchronized with the time master 101 by a sequence defined by a time synchronization protocol such as IEEE 1588/IEEE 802.1AS/IEEE 802.1AS Rev.

For example, the correction unit 121, in response to the synchronization signal received from the time master 101 via the network NW, performs data exchange with the time master 101 including transmission of a response signal to the synchronization signal, acquires an offset of the host clock 111 (host time) with respect to the time master 101 (reference time), and corrects the host clock 111 in accordance with the offset. For example, the data exchange includes transmitting a response signal to the synchronization signal and receiving reception time information of the response signal transmitted by the time master 101 in response to the response signal. The correction unit 121 performs a time synchronization sequence including performing the data exchange and calculating the offset based on a difference between the time indicated by the reception time information and the time when the response signal was transmitted, to acquire the offset.

The “response signal” is a signal transmitted from the correction unit 121 to the time master 101 after receiving the synchronization signal, in accordance with the time synchronization protocol. An example of the “response signal” is a Pdelay_Req signal in the time synchronization protocol. When the time master 101 transmits a Pdelay_Req signal, the “response signal” may be a Pdelay_Resp signal transmitted in response to the Pdelay_Req signal.

The correction unit 121 may further acquire transmission time information of the reception time information, and calculate the offset further based on a difference between the time when the reception time information was received and the time indicated by the transmission time information.

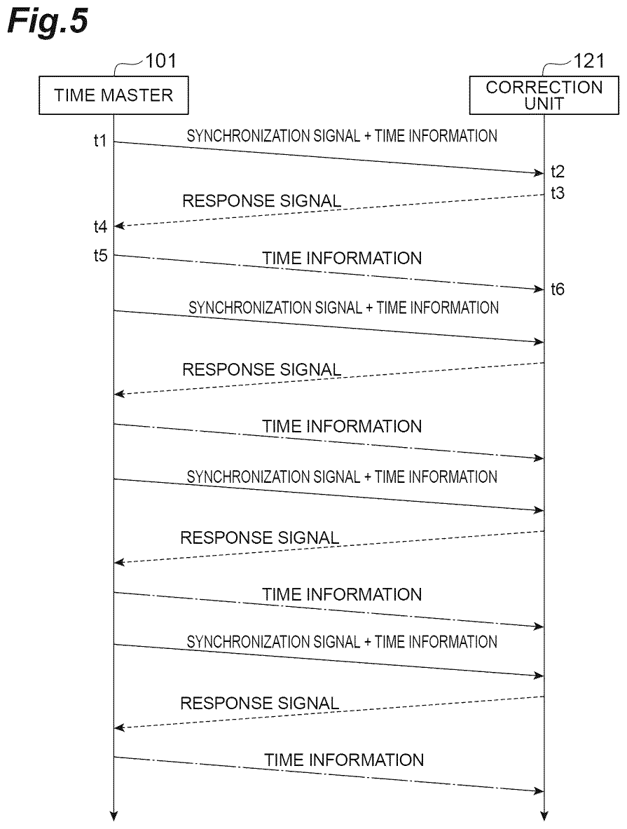

For example, as illustrated in FIG. 5, the time master 101 transmits a synchronization signal including transmission time information to the correction unit 121 at time t1. The correction unit 121 receives the synchronization signal at time t2 and transmits a response signal to the time master 101 at time t3. The time master 101 receives the response signal at time t4 and transmits reception time information (information of time t4) and transmission time information (information of time t5) represented by the reference time at time t5.

The correction unit 121 calculates the offset based on a difference between the time t6 when the reception time information was received and the time t5 indicated by the transmission time information, and a difference between the time t4 indicated by the reception time information and the time t3 when the response signal was transmitted. For example, the correction unit 121 calculates the offset ΔT by the following formula:

$$Δ T = \{ ( t 6 - t 5 ) + ( t 4 - t 3 ) \} / 2 \qquad ( 1 )$$

The correction unit 121 corrects the host clock 111 so as to eliminate the offset ΔT. For example, the correction unit 121 corrects the host clock 111 so as to generate a time obtained by subtracting the offset ΔT from the host time before correction.

Returning to FIG. 4, the local controller 300 further includes a first correction unit 321. The first correction unit 321 corrects the local clock 311 (local time) to be synchronized with the time master 101 (reference time). For example, the first correction unit 321 corrects the local clock 311 so as to be synchronized with the time master 101 by a sequence defined by a time synchronization protocol such as IEEE 1588/IEEE 802.1AS/IEEE 802.1AS Rev.

For example, the first correction unit 321, in response to the synchronization signal received from the time master 101 via the network NW, performs data exchange with the time master 101 including transmission of a response signal to the synchronization signal, acquires an offset of the local clock 311 (local time) with respect to the time master 101 (reference time), and performs a first correction process to correct the local clock 311 in accordance with the offset. For example, the data exchange includes transmitting a response signal to the synchronization signal and receiving reception time information of the response signal transmitted by the time master 101 in response to the response signal. The first correction unit 321 performs a time synchronization sequence including performing the data exchange via the communication system 4 and calculating the offset based on a difference between the time indicated by the reception time information and the time when the response signal was transmitted, to acquire the offset.

The first correction unit 321 may further acquire transmission time information of the reception time information, and calculate the offset further based on a difference between the time when the reception time information was received and the time indicated by the transmission time information.

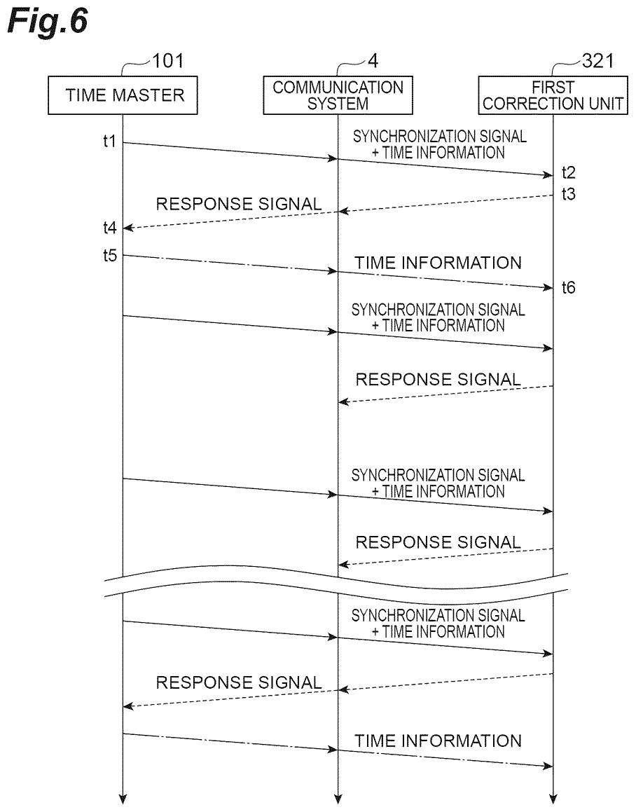

For example, as illustrated in FIG. 6, the time master 101 transmits a synchronization signal including transmission time information to the communication system 4 at time t1. The communication system 4 transmits the received synchronization signal to the first correction unit 321. The first correction unit 321 receives the synchronization signal at time t2 and transmits a response signal to the communication system 4 at time t3. The communication system 4 transmits the received response signal to the time master 101. The time master 101 receives the response signal at time t4 and transmits reception time information (information of time t4) and transmission time information (information of time t5) represented by the reference time to the communication system 4 at time t5. The communication system 4 transmits the received reception time information and transmission time information to the first correction unit 321.

The first correction unit 321 calculates the offset based on a difference between the time t6 when the reception time information is received and the time t5 indicated by the transmission time information, and a difference between the time t4 indicated by the reception time information and the time t3 when the response signal is transmitted. For example, the first correction unit 321 calculates the offset ΔT by the above formula (1). The first correction unit 321 performs the first correction process so as to eliminate the offset ΔT. For example, the first correction unit 321 corrects the local clock 311 so as to generate a time obtained by subtracting the offset ΔT from the local time before correction.

In this way, the time synchronization sequence of the local time is performed by data exchange via the communication system 4. For this reason, if the time synchronization sequence of the local time is performed every time a synchronization signal is transmitted, the communication load in the communication system 4 increases. Therefore, the control system 3 may be configured to periodically determine, for every two or more receptions of the synchronization signal via the network, a communication timing so that a frequency of the communication timing is reduced from a transmission frequency of the synchronization signal; periodically perform, in accordance with the communication timing periodically determined with the reduced frequency, data exchange with the time master including transmission of a response signal to the synchronization signal; and acquire an offset of the local clock with respect to the time master based on a result of the data exchange. For example, the control system 3 may further include a limiting unit that limits the frequency of the time synchronization sequence (the frequency of the first correction process) to be less than the transmission frequency of the synchronization signal. Since the data exchange for the first correction process is performed at a frequency less than the transmission frequency of the synchronization signal, the frequency of communication for time correction becomes low.

The limiting unit may be provided in each of the plurality of communication terminals 400. For example, as illustrated in FIG. 4, the communication terminal 400 includes a terminal communication unit 411 and a limiting unit 412. The terminal communication unit 411 performs communication with the base station device 200. For example, the terminal communication unit 411 receives the synchronization signal periodically transmitted by the time master 101, transmits the synchronization signal to the local controller 300, receives the response signal transmitted by the local controller 300, and transmits the response signal to the time master 101.

The limiting unit 412 limits the frequency of the first correction process to be less than the transmission frequency of the synchronization signal. For example, the limiting unit 412 limits the completion of the data exchange by blocking the response signal before the time master 101 receives the response signal, so as to limit the frequency of the first correction process to be less than the transmission frequency of the synchronization signal. When the limiting unit 412 blocks the response signal, the response signal is not received by the time master 101, as in the time synchronization sequences of the second and third cycles in FIG. 6, so the transmission of the reception time information from the time master 101 is not performed, and the data exchange is not completed. According to the configuration in which the response signal is blocked by the limiting unit 412, the communication load for time synchronization can be reduced even when the first correction unit 321 is not configured to reduce the transmission frequency of the response signal.

For example, the limiting unit 412 counts the number of receptions of the synchronization signal, transmits the response signal to the base station device 200 when the number of receptions is a multiple of a predetermined number that is two or more, and does not transmit the response signal to the base station device 200 by blocking the response signal when the number of receptions is not a multiple of the predetermined number.

When the synchronization signal includes identification information (hereinafter referred to as “synchronization ID”), the limiting unit 412 may determine whether to block the response signal based on the synchronization ID. The use of the synchronization ID can facilitate the regular limitation of the response signal.

For example, the limiting unit 412 performs filtering on the synchronization ID to extract a periodically repeating numerical value from the synchronization ID. The limiting unit 412 transmits the response signal to the base station device 200 when the extracted numerical value is a predetermined value, and does not transmit the response signal to the base station device 200 by blocking the response signal when the numerical value is not the predetermined value.

The limiting units 412 of the plurality of communication terminals 400 may limit the frequency of the first correction process so that the plurality of local controllers 300 perform the data exchange at mutually different timings. The time master 101 can be shared for the correction process in the plurality of local controllers 300 while preventing an increase in the communication load.

For example, the limiting units 412 of the plurality of communication terminals 400 may block the response signals from the corresponding local controllers 300 at mutually different timings. For example, each of the limiting units 412 of the plurality of communication terminals 400 may hold a unique predetermined value that does not overlap with the limiting units 412 of the other communication terminals 400, and may transmit the response signal to the base station device 200 when the numerical value extracted from the synchronization ID is the unique predetermined value, and may not transmit the response signal to the base station device 200 by blocking the response signal when the numerical value is not the unique predetermined value.

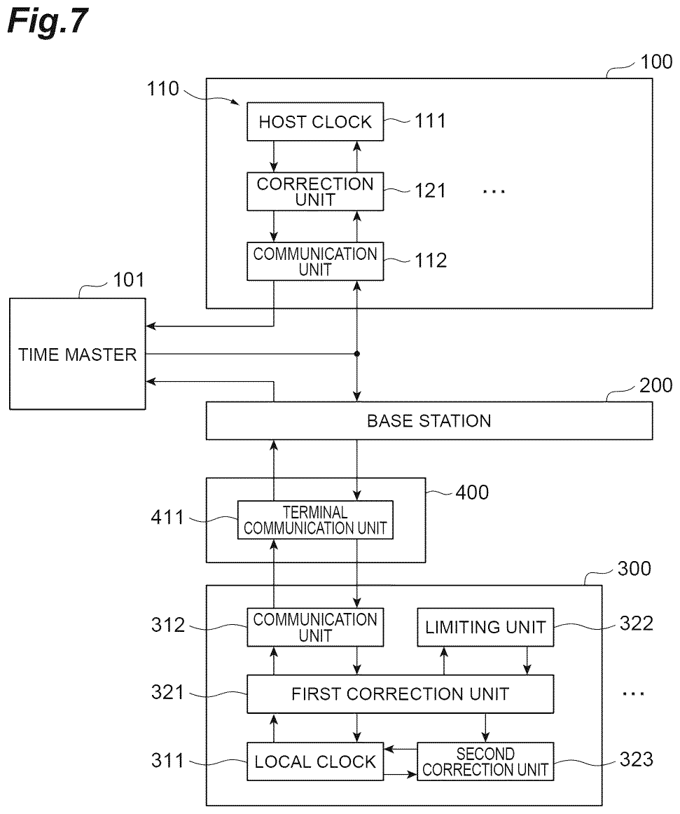

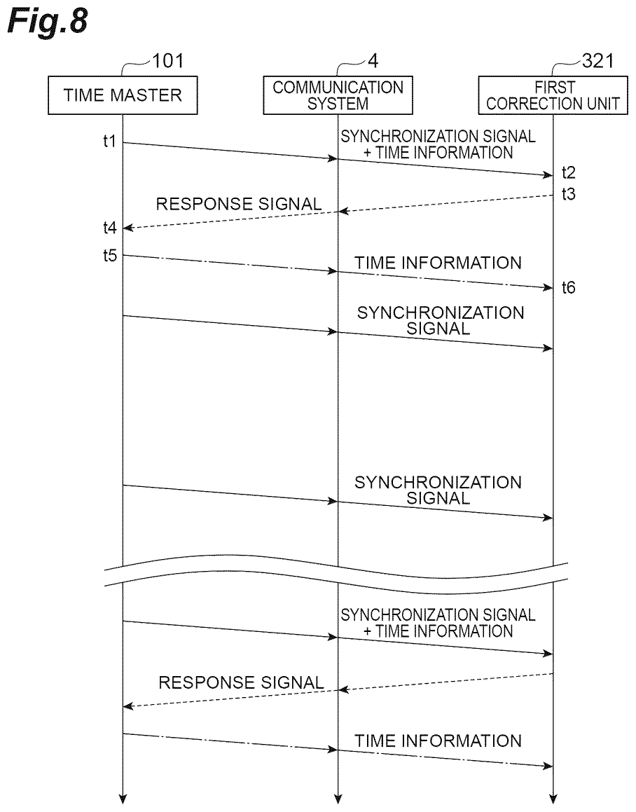

The limiting unit may be provided in each of the plurality of local controllers 300. For example, as illustrated in FIG. 7, each of the plurality of local controllers 300 may further include a limiting unit 322. The limiting unit 322 limits the initiation of the data exchange by the first correction unit 321 so as to limit the frequency of the first correction process. When the limiting unit 322 limits the initiation of the data exchange by the first correction unit 321, the response signal is not transmitted from the first correction unit 321, as in the time synchronization sequences of the second and third cycles in FIG. 8, so the data exchange is not initiated. According to the configuration in which the initiation of the data exchange is limited by the limiting unit 322, the communication load for time synchronization can be reduced even when a communication system 4 is used that causes all of the synchronization signals to be received by the first correction unit 321 and all of the response signals transmitted by the first correction unit 321 to be received by the time master 101 (for example, a communication system 4 in which the communication terminal 400 does not include the limiting unit 412).

For example, the limiting unit 322 counts the number of receptions of the synchronization signal, and causes the first correction unit 321 to transmit the response signal to the communication terminal 400 when the number of receptions is a multiple of a predetermined number that is two or more, and does not cause the first correction unit 321 to transmit the response signal to the communication terminal 400 when the number of receptions is not a multiple of the predetermined number.

The limiting unit 322 may determine whether to cause the first correction unit 321 to transmit the response signal to the communication terminal 400 based on the synchronization ID of the synchronization signal described above. The use of the synchronization ID can facilitate the regular limitation of the response signal.

For example, the limiting unit 322 performs filtering on the synchronization ID to extract a periodically repeating numerical value from the synchronization ID. The limiting unit 322 causes the first correction unit 321 to transmit the response signal to the communication terminal 400 when the extracted numerical value is a predetermined value, and does not cause the first correction unit 321 to transmit the response signal to the communication terminal 400 when the numerical value is not the predetermined value.

According to the configuration in which the local controller 300 includes the limiting unit 322, the frequency of the first correction process can be more flexibly adjusted based on the offset acquired by the first correction unit 321 and the like.

For example, the first correction unit 321 may repeatedly perform the first correction process at a first frequency to gradually decrease the offset, and the limiting unit 322 may, when the offset decreases so that a predetermined condition is satisfied, set a second frequency lower than the first frequency based on the offset and a predetermined allowable offset, and limit the frequency of the first correction process to the second frequency. Both the control of the offset based on the allowable offset and the reduction of the communication load can be readily achieved.

The first frequency is, for example, the transmission frequency of the synchronization signal. An example of the predetermined condition is that the offset becomes substantially constant. An example of the offset becoming substantially constant is that a difference between the offset and the offset in the previous first correction process falls below a predetermined threshold. The offset that has become substantially constant means the offset that occurs in the transmission period of the synchronization signal. For example, the limiting unit 322 calculates the time until the offset reaches the allowable offset based on the substantially constant offset and the transmission period of the synchronization signal, and sets the second frequency so that the first correction process is repeated at a period shorter than the calculated time.

The time master 101 may limit the transmission frequency of the synchronization signal in accordance with the frequency of the first correction process when the limiting unit 322 starts limiting the frequency of the first correction process. For example, the time master 101 may change the transmission frequency of the synchronization signal from the first frequency to the second frequency when the limiting unit 322 starts limiting the frequency of the first correction process to the second frequency. By also limiting the transmission frequency of the synchronization signal, the communication load can be further reduced. After the limitation of the transmission frequency of the synchronization signal is started, the limiting unit 322 causes the first correction unit 321 to transmit the response signal to the communication terminal 400 every time the limiting unit 322 receives a synchronization signal.

The limiting units 322 of the plurality of local controllers 300 may limit the frequency of the first correction process so that the plurality of local controllers 300 perform the data exchange at mutually different timings. The time master 101 can be shared for the correction process in the plurality of local controllers 300 while suppressing an increase in the communication load.

For example, the limiting units 322 of the plurality of local controllers 300 may limit the initiation of the data exchange by the first correction unit 321 at mutually different timings. For example, each of the limiting units 322 of the plurality of local controllers 300 may hold a unique predetermined value that does not overlap with the limiting units 322 of the other local controllers 300, and may cause the first correction unit 321 to transmit the response signal to the communication terminal 400 when the numerical value extracted from the synchronization ID is the unique predetermined value, and may not cause the first correction unit 321 to transmit the response signal to the communication terminal 400 when the numerical value is not the unique predetermined value.

The local controller 300 may be configured to further execute a second correction process to correct the local clock 311 at a timing (additional correction timing) different from the first correction process (the communication timing), based on the offset acquired in the data exchange for the first correction process. For example, as illustrated in FIG. 7, the local controller 300 may further include a second correction unit 323.

The second correction unit 323 acquires information on the offset from the first correction unit 321 and performs the second correction process at a timing different from the first correction process. By utilizing the offset acquired in the data exchange for the first correction process, the expansion of the offset during the period when the first correction process is not performed can be prevented. Therefore, both reducing the communication load by lowering the frequency of the first correction process and suppressing the offset of the local clock 311 with respect to the time master 101 can be achieved.

The second correction unit 323 may execute the second correction process based on the offset that satisfies the predetermined condition after the frequency of the first correction process is switched from the first frequency to the second frequency. When the offset decreases so that the predetermined condition is satisfied, between the offset and the amount by which the local clock 311 should be corrected in the second correction process becomes stronger. Therefore, by executing the second correction process after the frequency of the first correction process is switched from the first frequency to the second frequency, the offset of the local clock 311 with respect to the time master 101 can be further suppressed.

For example, the second correction unit 323 may perform the second correction process at the timing when the synchronization signal is received, and execute the second correction process with a correction amount equal to the offset that satisfied the predetermined condition. When the second correction process is performed at the timing when the synchronization signal is received, the correlation between the amount by which the local clock 311 should be corrected in the second correction process and the offset that satisfied the predetermined condition becomes even stronger. For example, when the offset is substantially constant, the amount by which the local clock 311 should be corrected in the second correction process at the timing when the synchronization signal is received is substantially the same as the offset. Therefore, the offset of the local clock 311 with respect to the time master 101 can be further suppressed.

The second correction unit 323 may set the execution timing of the second correction process based on the offset that satisfies the predetermined condition and a predetermined allowable offset, and execute the second correction process at the set execution timing. The offset based on the allowable offset (for example, suppressing the offset so as not to exceed the allowable offset) can be readily controlled.

For example, the second correction unit 323 may calculate the time until the offset reaches the allowable offset based on the substantially constant offset and the transmission period of the synchronization signal, and set the execution timing so that the second correction process is repeated at a period shorter than the calculated time. The allowable offset for setting the execution timing of the second correction process may be one period of the clock pulse in the local clock 311. Since the offset is suppressed to be equal to or less than the resolution of the local clock 311, a state where there is substantially no offset of the local clock 311 with respect to the time master 101 can be maintained.

The limiting units 322, 412 may limit the reception of the response signal by the time master 101 in a case where, in the first correction process scheduled to be executed by the first correction unit 321 in response to the synchronization signal, the response signal is not transmitted within a predetermined time from the reception time of the synchronization signal. The predetermined time is, for example, a time obtained by subtracting a predetermined margin from the transmission period of the synchronization signal. The margin may be set in consideration of fluctuations in data transmission time and the like.

For example, the limiting unit 412 may cause the transmission of the response signal by the terminal communication unit 411 to be canceled when the response signal that was scheduled to be transmitted by the terminal communication unit 411 for the synchronization signal received by the terminal communication unit 411 is received by the terminal communication unit 411 after a predetermined time has elapsed from the reception time of the synchronization signal by the terminal communication unit 411. This avoids the delayed response signal from being received by the time master 101.

The limiting unit 322 may cause the transmission of the response signal by the first correction unit 321 to be canceled when the response signal that was scheduled to be transmitted by the first correction unit 321 for the synchronization signal received by the first correction unit 321 is not transmitted by the first correction unit 321 even after a predetermined time has elapsed from the reception time of the synchronization signal by the first correction unit 321. This avoids the delayed response signal from being received by the time master 101.

The control system 3 may further include devices other than the local controller 300, and the other devices may be connected to the wireless communication network NW2 via the communication terminal 400. The other devices may include the local clock 311, the first correction unit 321, and the second correction unit 323. Examples of the other devices include data collection devices that collect data in time series from sensors and the like, data processing terminals such as personal computers or tablet computers, and operator work assistance devices such as AR glasses.

Further, one communication terminal 400 may be shared by a plurality of devices.

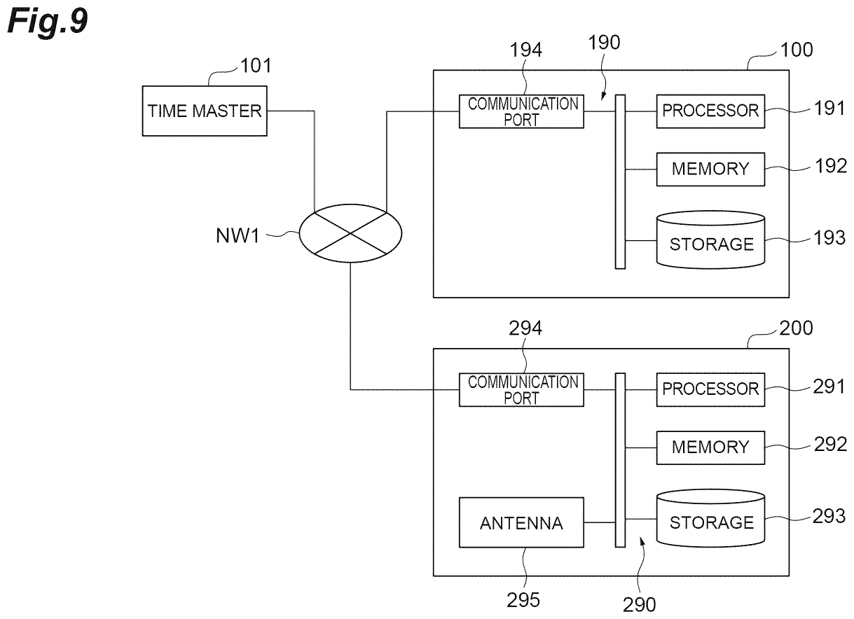

FIG. 9 is a block diagram illustrating a hardware configuration of the control system 3. As illustrated in FIG. 9, the control server 100 includes circuitry 190. The circuitry 190 includes a processor 191, a memory 192, a storage 193, and a communication port 194. The storage 193 is configured by one or more non-volatile memory devices such as a flash memory or a hard disk. The storage 193 stores a program for causing the control server 100 to configure the plurality of controllers 110. The memory 192 is configured by one or more volatile memory devices such as a random-access memory. The memory 192 temporarily stores the program loaded from the storage 193. The processor 191 is configured by one or more arithmetic devices such as a central processing unit (CPU) or a graphics processing unit (GPU). The processor 191 executes the program loaded into the memory 192 to cause the control server 100 to configure the plurality of controllers 110. The calculation result by the processor 191 is temporarily stored in the memory 192. The communication port 194 communicates with the time master 101 and the base station device 200 via the wired communication network NW1 in response to a request from the processor 191.

The base station device 200 includes circuitry 290. The circuitry 290 includes a processor 291, a memory 292, a storage 293, and a communication port 294. The storage 293 is configured by one or more non-volatile memory devices such as a flash memory or a hard disk. The storage 293 stores a program for causing the base station device 200 to execute communication with the time master 101 and the control server 100, and communication with the plurality of communication terminals 400. The memory 292 is configured by one or more volatile memory devices such as a random-access memory. The memory 292 temporarily stores the program loaded from the storage 293. The processor 291 is configured by one or more arithmetic devices such as a central processing unit (CPU) or a graphics processing unit (GPU). The processor 291 executes the program loaded into the memory 292 to cause the base station device 200 to execute communication with the time master 101 and the control server 100, and communication with the plurality of communication terminals 400. The calculation result by the processor 291 is temporarily stored in the memory 292. The communication port 294 communicates with the time master 101 and the control server 100 via the wired communication network NW1 in response to a request from the processor 291. The antenna 295 transmits and receives signals for wireless communication with the plurality of communication terminals 400 in response to a request from the processor 291.

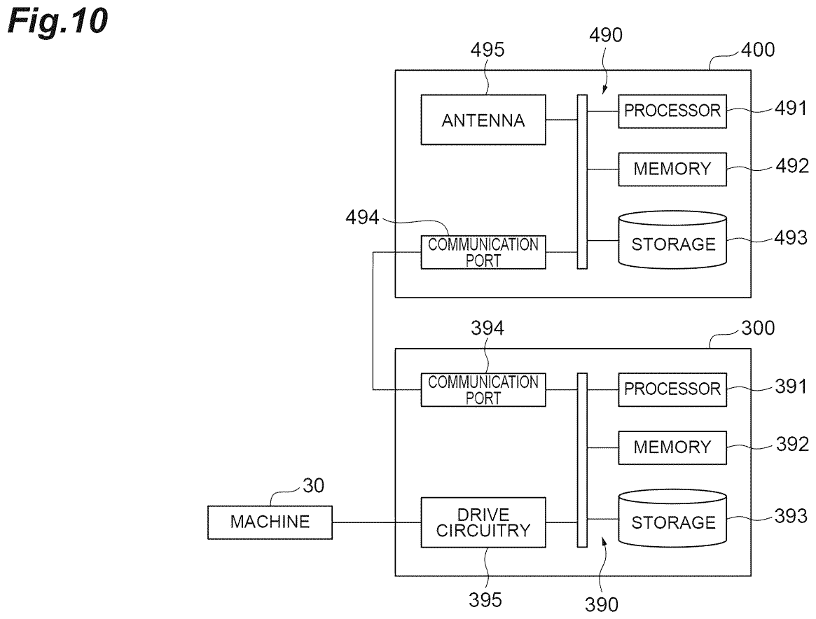

As illustrated in FIG. 10, the communication terminal 400 includes circuitry 490. The circuitry 490 includes a processor 491, a memory 492, a storage 493, an antenna 494, and a communication port 495. The storage 493 is configured by one or more non-volatile memory devices such as a flash memory or a hard disk. The storage 493 stores a program for causing the communication terminal 400 to configure the functional blocks described above. The antenna 494 transmits and receives signals for wireless communication with the base station device 200 in response to a request from the processor 491. The communication port 495 performs communication with the local controller 300 in response to a request from the processor 491.

The local controller 300 includes circuitry 390. The circuitry 390 includes a processor 391, a memory 392, a storage 393, a communication port 394, and drive circuitry 395. The storage 393 is configured by one or more non-volatile memory devices such as a flash memory or a hard disk. The storage 393 stores a program for causing the local controller 300 to configure the functional blocks described above. The communication port 394 performs communication with the communication terminal 400 in response to a request from the processor 391. The drive circuitry 395 outputs drive power to the machine 2 and acquires feedback data from the machine 2 in response to a request from the processor 391. The hardware configuration illustrated above is merely an example and can be changed. For example, the base station device 200 may be incorporated into the control server 100, and the communication terminal 400 may be incorporated into the local controller 300.

### [Control Procedure]

Next, an example control procedure for the machine 2 by the control system 3 will be described. This procedure includes a host clock synchronization procedure, a local clock synchronization procedure, a host control procedure, and a local control procedure. These procedures are executed in parallel with each other. Hereinafter, each example procedure will be described.

### (Host Clock Synchronization Procedure)

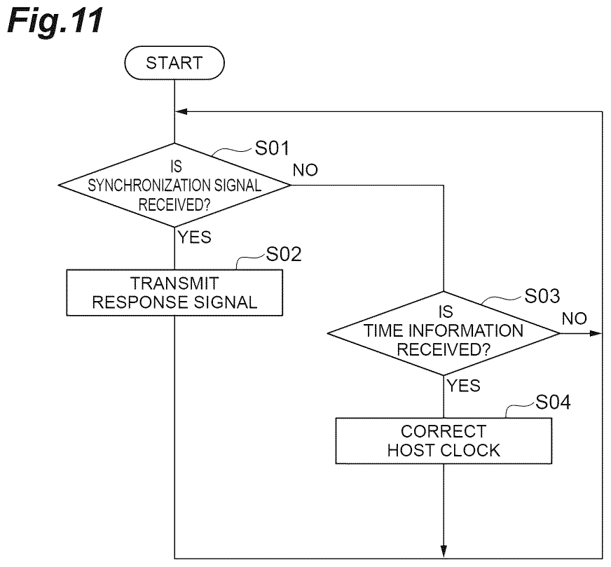

As illustrated in FIG. 11, the control server 100 first executes operation S01. In operation S01, the correction unit 121 checks whether the communication unit 112 has received a synchronization signal from the time master 101. If it is determined in operation S01 that a synchronization signal has been received, the control server 100 executes operation S02. In operation S02, the correction unit 121 transmits a response signal to the time master 101.

If it is determined in operation S01 that a synchronization signal has not been received, the control server 100 executes operation S03. In operation S03, the correction unit 121 checks whether the communication unit 112 has received the reception time information and the transmission time information from the time master 101. If it is determined in operation S03 that the reception time information and the transmission time information have been received, the control server 100 executes operation S04. In operation S04, the correction unit 121 calculates the offset as described above and corrects the host clock 111 based on the calculated offset.

After operation S02 or S04, the control server 100 returns the process to operation S01. If it is determined in operation S03 that the reception time information and the transmission time information have not been received, the control server 100 returns the process to operation S01 without executing operations S02 and S04. The control server 100 repeatedly executes the above processing.

### (Local Clock Synchronization Procedure)

This procedure includes: receiving a synchronization signal periodically transmitted by the time master 101 via the network NW; performing, in response to the synchronization signal, data exchange with the time master 101 including transmission of a response signal to the synchronization signal, acquiring an offset of the local clock 311 with respect to the time master 101, and performing a first correction process to correct the local clock 311 in accordance with the offset; and limiting a frequency of the first correction process to be less than a transmission frequency of the synchronization signal.

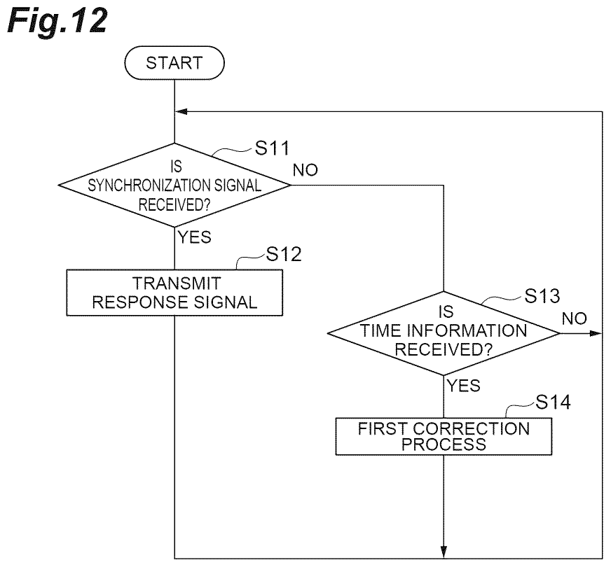

For example, this procedure includes a local clock 311 synchronization procedure performed by the local controller 300 and a limiting procedure performed by the communication terminal 400. FIG. 12 is a flowchart illustrating the local clock 311 synchronization procedure performed by the local controller 300. As illustrated in FIG. 12, the local controller 300 first executes operation S11. In operation S11, the first correction unit 321 checks whether the communication unit 312 has received a synchronization signal from the time master 101. If it is determined in operation S11 that a synchronization signal has been received, the local controller 300 executes operation S12. In operation S12, the first correction unit 321 transmits a response signal to the time master 101.

If it is determined in operation S11 that a synchronization signal has not been received, the local controller 300 executes operation S13. In operation S13, the first correction unit 321 checks whether the communication unit 312 has received the reception time information and the transmission time information from the time master 101. If it is determined in operation S13 that the reception time information and the transmission time information have been received, the local controller 300 executes operation S14. In operation S14, the first correction unit 321 calculates the offset as described above and corrects the local clock 311 by the first correction process based on the calculated offset.

After operation S12 or S14, the local controller 300 returns the process to operation S11. If it is determined in operation S13 that the reception time information and the transmission time information have not been received, the local controller 300 returns the process to operation S11 without executing operations S12 and S14. The local controller 300 repeatedly executes the above processing.

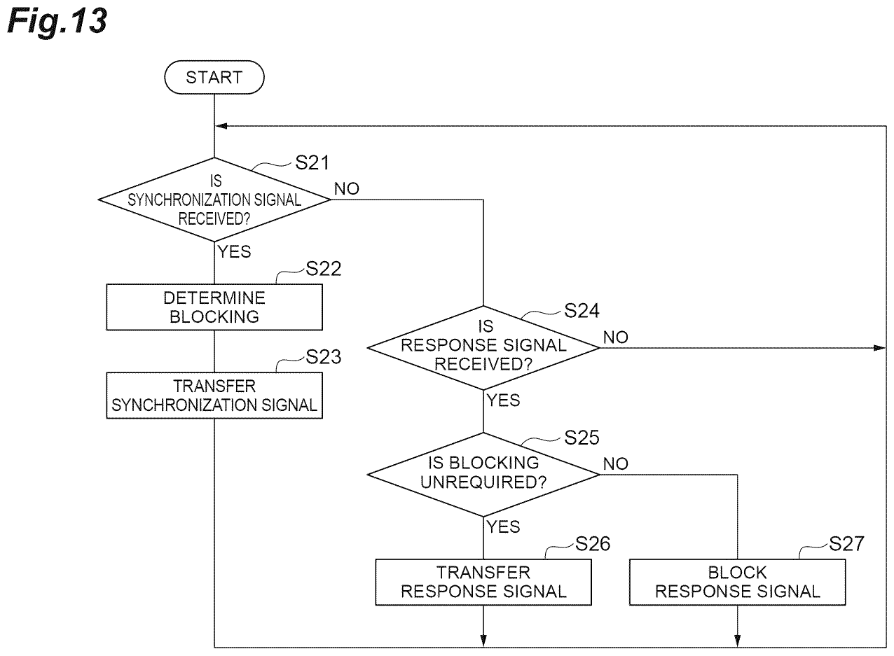

FIG. 13 is a flowchart illustrating a limiting procedure performed by the communication terminal 400. As illustrated in FIG. 13, the communication terminal 400 first executes operation S21. In operation S21, the limiting unit 412 checks whether the terminal communication unit 411 has received a synchronization signal from the time master 101. If it is determined in operation S21 that the terminal communication unit 411 has received a synchronization signal, the communication terminal 400 executes operations S22 and S23. In operation S22, the limiting unit 412 determines whether to block the response signal to the synchronization signal received by the terminal communication unit 411.

For example, the limiting unit 412 performs filtering on the synchronization ID to extract a periodically repeating numerical value from the synchronization ID, turns off a block flag when the extracted numerical value is a predetermined value, and turns on the block flag when the numerical value is not the predetermined value.

In operation S23, the terminal communication unit 411 transfers the synchronization signal to the local controller 300. If it is determined in operation S21 that the terminal communication unit 411 has not received a synchronization signal from the time master 101, the communication terminal 400 executes operation S24. In operation S24, the limiting unit 412 checks whether the terminal communication unit 411 has received a response signal from the local controller 300. If it is determined in operation S24 that a response signal has been received, the communication terminal 400 executes operation S25.

In operation S25, the limiting unit 412 determines whether to block the response signal. For example, the limiting unit 412 determines not to block the response signal when the block flag is off, and determines block the response signal when the block flag is on.

If it is determined in operation S25 not to block the response signal, the communication terminal 400 executes operation S26. In operation S26, the limiting unit 412 causes the terminal communication unit 411 to transfer the response signal to the base station device 200. If it is determined in operation S25 to block the response signal, the communication terminal 400 executes operation S27. In operation S27, the limiting unit 412 causes the terminal communication unit 411 to block the response signal. For example, the limiting unit 412 causes the transfer of the response signal from the terminal communication unit 411 to the base station device 200 to be canceled.

After operation S23, S26, or S27, the communication terminal 400 returns the process to operation S21. If it is determined in operation S24 that a response signal has not been received, the communication terminal 400 returns the process to operation S21 without executing operations S23, S26, and S27. The communication terminal 400 repeats the above procedure.

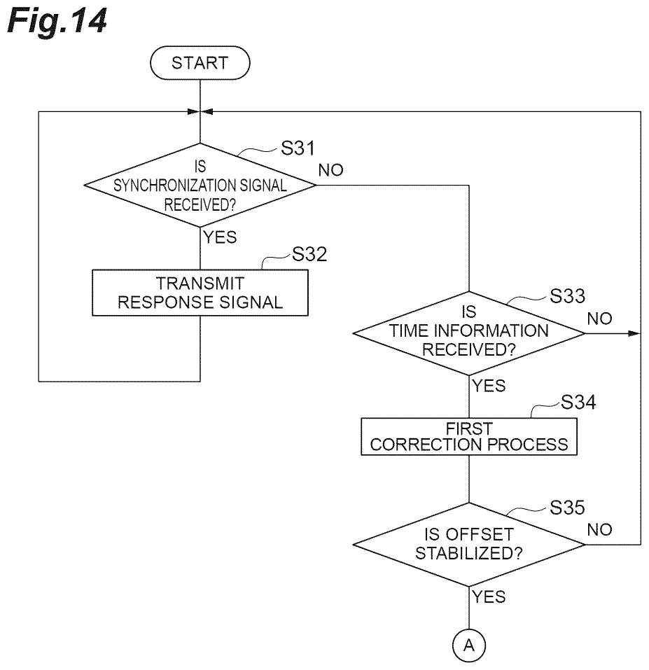

As described above, both the local clock 311 synchronization procedure and the limiting procedure may be performed by the local controller 300. FIG. 14 is a flowchart illustrating a procedure in which the local controller 300 performs both the local clock 311 synchronization procedure and the limiting procedure. As illustrated in FIG. 14, the local controller 300 first executes operation S31. In operation S31, the first correction unit 321 checks whether the communication unit 312 has received a synchronization signal from the time master 101. If it is determined in operation S31 that a synchronization signal has been received, the local controller 300 executes operation S32. In operation S32, the first correction unit 321 transmits a response signal to the time master 101. Thereafter, the local controller 300 returns the process to operation S31.

If it is determined in operation S31 that a synchronization signal has not been received, the local controller 300 executes operation S33. In operation S33, the first correction unit 321 checks whether the communication unit 312 has received the reception time information and the transmission time information from the time master 101. If it is determined in operation S33 that the reception time information and the transmission time information have been received, the local controller 300 executes operation S34. In operation S34, the first correction unit 321 calculates the offset as described above and corrects the local clock 311 by the first correction process based on the calculated offset.

Next, the local controller 300 executes operation S35. In operation S35, the local controller 300 checks whether the offset has become substantially constant. If it is determined in operation S35 that the offset has not become constant, the local controller 300 returns the process to operation S31. If it is determined in operation S33 that the reception time information and the transmission time information have not been received, the local controller 300 returns the process to operation S31 without executing operations S34 and S35. Thereafter, until the offset becomes constant, the local clock 311 is corrected by the first correction process every time a synchronization signal is received.

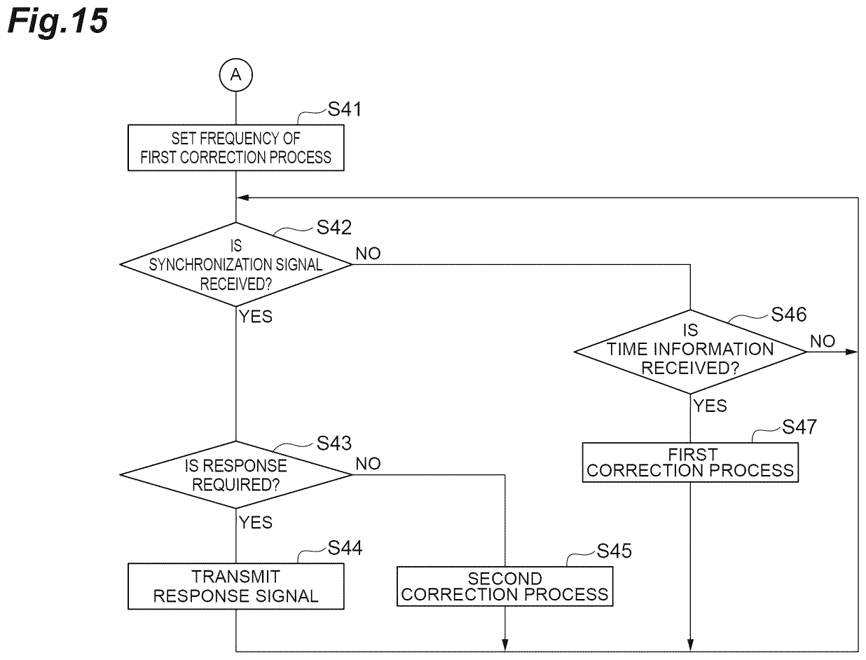

If it is determined in operation S35 that the offset has become substantially constant, the local controller 300 executes operation S41 as illustrated in FIG. 15. In operation S41, the limiting unit 322 sets a second frequency lower than the first frequency based on the offset and a predetermined allowable offset, and limits the frequency of the first correction process to the second frequency. For example, the limiting unit 322 sets the above-mentioned predetermined value (the predetermined value for comparison with the numerical value extracted from the synchronization ID) so that the frequency of the first correction process becomes the second frequency.

Next, the communication terminal 400 executes operation S42. In operation S42, the first correction unit 321 checks whether the communication unit 312 has received a synchronization signal from the time master 101.

If it is determined in operation S42 that a synchronization signal has been received, the local controller 300 executes operation S43. In operation S43, the limiting unit 322 determines whether to transmit a response signal. For example, the limiting unit 322 performs filtering on the synchronization ID to extract a periodically repeating numerical value from the synchronization ID, and determines to transmit the response signal when the extracted numerical value is a predetermined value, and determines not to transmit the response signal when the numerical value is not the predetermined value.

If it is determined in operation S43 to transmit the response signal, the local controller 300 executes operation S44. In operation S44, the limiting unit 322 causes the first correction unit 321 to transmit the response signal to the time master 101.

If it is determined in operation S43 not to transmit the response signal, the local controller 300 executes operation S45. In operation S45, the second correction unit 323 corrects the local clock 311 by the second correction process.

If it is determined in operation S42 that a synchronization signal has not been received, the local controller 300 executes operation S46. In operation S46, the first correction unit 321 checks whether the communication unit 312 has received the reception time information and the transmission time information from the time master 101. If it is determined in operation S46 that the reception time information and the transmission time information have been received, the local controller 300 executes operation S47. In operation S47, the first correction unit 321 calculates the offset as described above and corrects the local clock 311 by the first correction process based on the calculated offset.

After operation S44, S45, or S47, the local controller 300 returns the process to operation S42. If it is determined in operation S46 that the reception time information and the transmission time information have not been received, the local controller 300 returns the process to operation S42 without executing operations S44, S45, and S47. Thereafter, operations S42 to S47 are repeated.

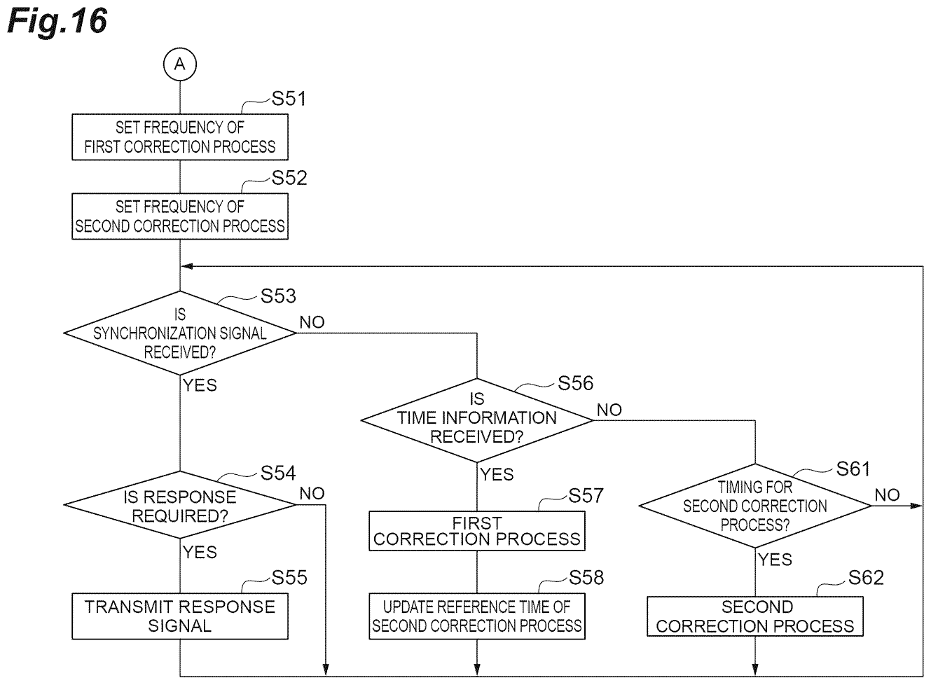

After the offset has become substantially constant, the local controller 300 may determine the execution timing so that the second correction process is performed before the offset exceeds the allowable offset, and execute the second correction process. For example, as illustrated in FIG. 16, the local controller 300 executes operation S52 after executing operation S51, which is the same as operation S41. In operation S52, the second correction unit 323 sets the execution period of the second correction process so that the second correction process is performed before the offset exceeds the allowable offset.

Next, the local controller 300 executes operation S53. In operation S53, similarly to operation S42, the first correction unit 321 checks whether the communication unit 312 has received a synchronization signal from the time master 101.

If it is determined in operation S53 that a synchronization signal has been received, the local controller 300 executes operation S54. In operation S54, similarly to operation S43, the limiting unit 322 determines whether to transmit a response signal.

If it is determined in operation S54 to transmit the response signal, the local controller 300 executes operation S55. In operation S55, similarly to operation S44, the limiting unit 322 causes the first correction unit 321 to transmit the response signal to the time master 101.

Thereafter, the local controller 300 returns the process to operation S53. If it is determined in operation S54 not to transmit the response signal, the local controller 300 returns the process to operation S53 without executing operation S55.

If it is determined in operation S53 that the communication unit 312 has not received a synchronization signal, the local controller 300 executes operation S56. In operation S56, similarly to operation S46, the first correction unit 321 checks whether the communication unit 312 has received the reception time information and the transmission time information from the time master 101. If it is determined in operation S56 that the reception time information and the transmission time information have been received, the local controller 300 executes operations S57 and S58. In operation S57, similarly to operation S47, the first correction unit 321 calculates the offset as described above and corrects the local clock 311 by the first correction process based on the calculated offset. In operation S58, the second correction unit 323 stores the current time as a reference time for the elapsed time.

If it is determined in operation S56 that the reception time information and the transmission time information have not been received, the local controller 300 executes operation S61. In operation S61, the second correction unit 323 checks whether it is the execution timing of the second correction process. For example, in operation S61, the second correction unit 323 checks whether the elapsed time from the reference time is a multiple of the execution period of the second correction process.

If it is determined in operation S61 that it is the execution timing of the second correction process, the local controller 300 executes operation S62. In operation S62, the second correction unit 323 corrects the local clock 311 by the second correction process. After operations S58 and S62, the local controller 300 returns the process to operation S53. If it is determined in operation S61 that it is not the execution timing of the second correction process, the local controller 300 returns the process to operation S53 without executing operations S57, S58, and S62. Thereafter, operations S53 to S62 are repeated.

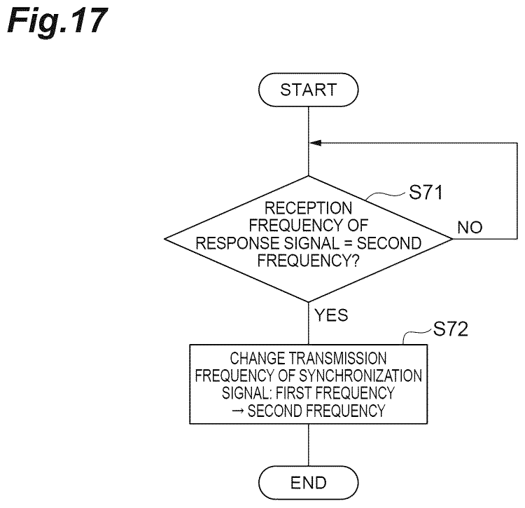

As described above, the time master 101 may limit the transmission frequency of the synchronization signal in accordance with the frequency of the first correction process when the limiting unit 322 starts limiting the frequency of the first correction process. For example, as illustrated in FIG. 17, the time master 101 executes operations S71 and S72. In operation S71, the time master 101 waits for the reception frequency of the response signal to become the second frequency. In operation S72, the time master 101 changes the transmission frequency of the synchronization signal from the first frequency to the second frequency. As a result, after the limitation of the transmission frequency of the synchronization signal is started, the limiting unit 322 causes the first correction unit 321 to transmit the response signal to the communication terminal 400 every time it receives a synchronization signal.

### (Host Control Procedure)

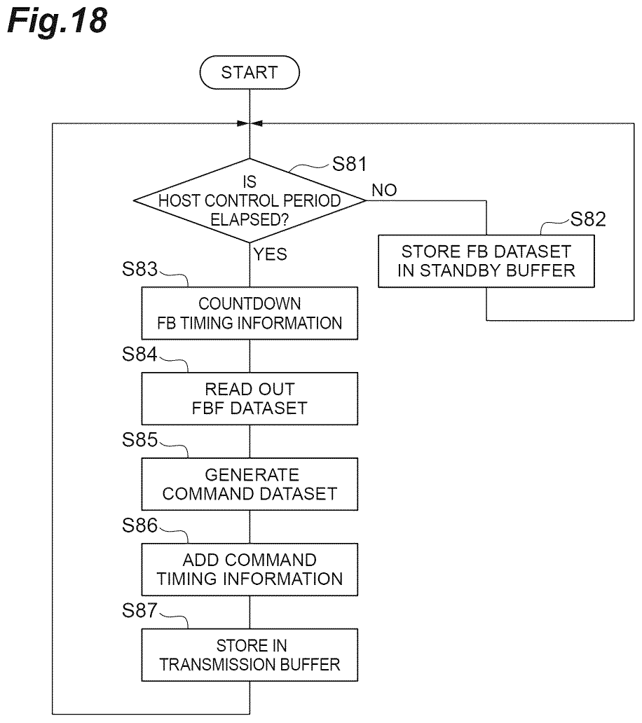

As illustrated in FIG. 18, the control server 100 executes operation S81. In operation S81, the read-out unit 114 checks whether the host time is a multiple of the control cycle.

If it is determined in operation S81 that the host time is not a multiple of the control cycle, the control server 100 executes operation S82. In operation S82, the communication unit 112 acquires feedback data from the base station device 200 and converts the feedback timing information into the number of cycles of the control cycle from the current time to the feedback timing. The communication unit 112 stores the feedback data including the feedback timing information converted into the number of cycles in the standby buffer 113. Thereafter, the control server 100 returns the process to operation S81.

If it is determined in operation S81 that the host time is a multiple of the control cycle, the control server 100 executes operations S83, S84, S85, S86, and S87. In operation S83, the read-out unit 114 counts down the feedback timing information in all the feedback data stored in the standby buffer 113.

In operation S84, the read-out unit 114 reads out the feedback data whose feedback timing information has become zero from the standby buffer 113. In operation S85, the control calculation unit 115 generates command data based on the feedback data read out by the read-out unit 114.

In operation S86, the control calculation unit 115 adds command timing information to the generated command data. In operation S87, the control calculation unit 115 causes the communication unit 112 to transmit the command data to which the command timing information is added to the base station device 200. After operation S87, the control server 100 returns the process to operation S81. The control server 100 repeatedly executes the above procedure.

### (Local Control Procedure)

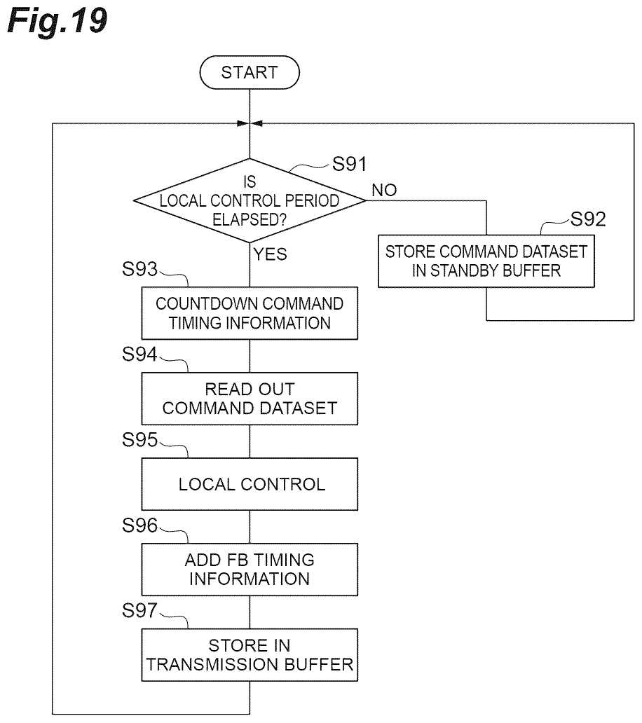

As illustrated in FIG. 19, the local controller 300 executes operation S91. In operation S91, the read-out unit 314 checks whether the local time is a multiple of the control cycle.

If it is determined in operation S91 that the local time is not a multiple of the control cycle, the local controller 300 executes operation S92. In operation S92, the communication unit 312 acquires command data from the communication terminal 400 and converts the command timing information into the number of cycles of the control cycle from the current time to the command timing. The communication unit 312 stores the command data including the command timing information converted into the number of cycles in the standby buffer 313. Thereafter, the local controller 300 returns the process to operation S91.

If it is determined in operation S91 that the local time is a multiple of the control cycle, the local controller 300 executes operations S93, S94, S95, S96, and S97. In operation S93, the read-out unit 314 counts down the command timing information in all the command data stored in the standby buffer 313.

In operation S94, the read-out unit 314 reads out the command data whose command timing information has become zero from the standby buffer 313. In operation S95, the control unit 315 controls the machine 2 based on the command data read out by the read-out unit 314, and acquires the feedback data from the machine 2.

In operation S96, the control unit 315 adds feedback timing information to the acquired feedback data. In operation S97, the control unit 315 causes the communication unit 312 to transmit the feedback data to which the feedback timing information is added to the communication terminal 400. After operation S97, the local controller 300 returns the process to operation S91. The local controller 300 repeatedly executes the above procedure.

### Summary

The examples described above include the following configurations.

(1) A control system 3 including: a time master 101 configured to periodically transmit a synchronization signal for time synchronization via a network NW; and a local controller connected to the time master 101 via the network NW and configured to control a machine 2, wherein the local controller includes: a local clock 311; and a first correction unit 321 configured to, in response to the synchronization signal received via the network NW, perform data exchange with the time master 101 including transmission of a response signal to the synchronization signal, acquire an offset of the local clock 311 with respect to the time master 101, and perform a first correction process to correct the local clock 311 in accordance with the offset, and wherein the control system 3 further includes a limiting unit 322, 412 configured to limit a frequency of the first correction process to be less than a transmission frequency of the synchronization signal.

According to this control system 3, since the data exchange for the first correction process is performed at a frequency less than the transmission frequency of the synchronization signal, the frequency of communication for time correction becomes low. Therefore, it is beneficial for reducing the communication load for time synchronization.

(2) The control system 3 according to (1), wherein the limiting unit 412 is configured to limit the frequency of the first correction process by blocking the response signal transmitted from the first correction unit 321 before the time master 101 receives the response signal, thereby preventing completion of the data exchange by the first correction unit 321.

Even when the first correction unit 321 is not configured to reduce the transmission frequency of the response signal, the communication load for time synchronization can be reduced.

(3) The control system 3 according to (2), wherein the limiting unit 412 is configured to determine whether to block the response signal to the synchronization signal based on identification information included in the synchronization signal.

The use of the identification information can facilitate the regular limitation of the response signal.

(4) The control system 3 according to (1), wherein the limiting unit 322 is configured to limit initiation of the data exchange by the first correction unit 321 so as to limit the frequency of the first correction process.

Even when a communication system is used that causes all of the synchronization signals transmitted from the time master 101 to be received by the first correction unit 321 and all of the response signals transmitted by the first correction unit 321 to be received by the time master 101, the communication load for time synchronization can be reduced.

(5) The control system 3 according to any one of (1) to (4), wherein the limiting unit 322, 412 is configured to limit reception of the response signal by the time master 101 in a case where, in the first correction process scheduled to be executed by the first correction unit 321 in response to the synchronization signal, the response signal is not transmitted within a predetermined time from a reception time of the synchronization signal.

An instantaneous increase in communication load due to a delayed response signal and a response signal to the next synchronization signal can be prevented.

(6) The control system 3 according to any one of (1) to (5), wherein the local controller includes: a communication unit 312 configured to exchange, with an application, control data having a designation of a periodic timing for periodic communication with the application via the network NW that is non-periodic; and a control unit 315 configured to control the machine 2 using the control data at the designated timing based on the local clock 311.

By being based on the local clock 311 that is time-synchronized with the time master 101, reliable periodic communication can be performed. By reducing the communication load for time synchronization, a margin for communication resources for periodic communication can be provided.

(7) The control system 3 according to (4), wherein the local controller further includes a second correction unit 323 configured to perform a second correction process to correct the local clock 311 at a timing different from a timing of the first correction process, based on the offset acquired in the data exchange for the first correction process. By utilizing the offset acquired in the data exchange for the first correction process, the expansion of the offset during the period when the first correction process is not performed can be prevented. Therefore, both reducing the communication load by lowering the frequency of the first correction process and suppressing the offset of the local clock 311 with respect to the time master 101 can be achieved.

(8) The control system 3 according to (7), wherein the first correction unit 321 is configured to repeatedly perform the first correction process at a first frequency to gradually decrease the offset, wherein the limiting unit 322 is configured to switch the frequency of the first correction process to a second frequency lower than the first frequency if the offset decreases so that a predetermined condition is satisfied, and wherein the second correction unit 323 is configured to execute the second correction process based on the offset that satisfies the predetermined condition after the frequency of the first correction process is switched from the first frequency to the second frequency. When the offset decreases so that the predetermined condition is satisfied, the correlation between the offset and the amount by which the local clock 311 should be corrected in the second correction process becomes stronger. Therefore, by executing the second correction process after the frequency of the first correction process is switched from the first frequency to the second frequency, the offset of the local clock 311 with respect to the time master 101 can be further suppressed.

(9) The control system 3 according to (8), wherein the second correction unit 323 is configured to perform the second correction process at a timing when the synchronization signal is received.

When the second correction process is performed at the timing when the synchronization signal is received, the correlation between the amount by which the local clock 311 should be corrected in the second correction process and the offset that satisfied the predetermined condition becomes even stronger. Therefore, the offset of the local clock 311 with respect to the time master 101 can be further suppressed.

(10) The control system 3 according to (8) or (9), wherein the second correction unit 323 is configured to: set an execution timing of the second correction process based on the offset that satisfies the predetermined condition and a predetermined allowable offset; and execute the second correction process at the set execution timing.

The offset based on the allowable offset (for example, suppressing the offset so as not to exceed the allowable offset) can be readily controlled.

(11) The control system 3 according to any one of (4) to (10), wherein the first correction unit 321 is configured to repeatedly perform the first correction process at a first frequency to gradually decrease the offset, and wherein the limiting unit 322 is configured to: set a second frequency lower than the first frequency based on the offset and a predetermined allowable offset if the offset decreases so that a predetermined condition is satisfied; and limit the frequency of the first correction process to the second frequency.

Both the control of the offset based on the allowable offset and the reduction of the communication load can be readily achieved.

(12) The control system 3 according to any one of (4) to (11), wherein the first correction unit 321 is configured to repeatedly perform the first correction process at a frequency equal to the transmission frequency of the synchronization signal to gradually decrease the offset, wherein the limiting unit 322 is configured to start limiting the frequency of the data exchange if the offset decreases so that a predetermined condition is satisfied, and wherein the time master 101 is configured to limit the transmission frequency of the synchronization signal in accordance with the frequency of the first correction process if the limiting unit 322 starts limiting the frequency of the data exchange.

By also limiting the transmission frequency of the synchronization signal, the communication load can be further reduced.

(13) The control system 3 according to any one of (1) to (12), further including a plurality of local controllers including the local controller, wherein each of the plurality of local controllers includes the local clock 311 and the first correction unit 321, and the limiting unit 322, 412 is configured to limit the frequency of the first correction process so that the plurality of local controllers perform the data exchange at mutually different timings.

The time master 101 can be shared for the correction process in the plurality of local controllers while suppressing an increase in the communication load.

(14) A communication terminal including: a terminal communication unit 411 configured to: receive a synchronization signal periodically transmitted by a time master 101 and transmit the synchronization signal to a local controller having a local clock 311; and receive a response signal to the synchronization signal and transmit the response signal to the time master, the response signal being transmitted by the local controller for data exchange to acquire an offset of the local clock 311 with respect to the time master 101; and a limiting unit 412 configured to limit completion of the data exchange by blocking the response signal before the time master 101 receives the response signal so as to limit a frequency of the first correction process to be less than a transmission frequency of the synchronization signal.

(15) A communication method including: receiving a synchronization signal periodically transmitted by a time master 101 via a network NW; performing data exchange with the time master 101 including transmission of a response signal to the synchronization signal in response to the synchronization signal, acquiring an offset of a local clock 311 with respect to the time master 101, and performing a first correction process to correct the local clock 311 in accordance with the offset; and limiting a frequency of the first correction process to be less than a transmission frequency of the synchronization signal.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A control system comprising:
a time master configured to periodically transmit synchronization signals for time synchronization via a network; and
circuitry connected to the time master via the network,
wherein the circuitry comprises a local clock and is configured to:
periodically determine, for every two or more receptions of the synchronization signal via the network, a communication timing so that a frequency of the communication timing is reduced from a transmission frequency of the synchronization signal;
periodically perform, in accordance with the communication timing periodically determined with the reduced frequency, data exchange with the time master including transmission of a response signal to the synchronization signal;
acquire an offset of the local clock with respect to the time master based on a result of the data exchange;
correct the local clock in accordance with the offset; and
control a machine based on the corrected local clock.

2. The control system according to claim 1, wherein the circuitry comprises:
a communication terminal connected to the time master via the network; and
control circuitry communicable with the communication terminal and configured to:
receive the synchronization signal via the communication terminal;
transmit, in response to receiving the synchronization signal, the response signal to the communication terminal for the data exchange;
acquire the offset of the local clock based on the result of the data exchange; and
correct the local clock in accordance with the offset; and
control the machine based on the corrected local clock,
wherein the communication terminal is configured to:
periodically determine, for every two or more receptions of the synchronization signal via the network, a communication timing so that a frequency of the communication timing is reduced from a transmission frequency of the synchronization signal;
receive the response signal from the control circuitry;
transmit, to the time master, the received response signal that corresponds to the determined communication timing so that the data exchange is performed;
block the response signal that does not correspond to the communication timing, thereby preventing completion of the data exchange.

3. The control system according to claim 1, wherein the circuitry is configured to determine the communication timing based on identification information included in the synchronization signal.

4. The control system according to claim 1, wherein the circuitry comprises:
a communication terminal connected to the time master via the network; and
control circuitry communicable with the communication terminal and configured to:
periodically determine, for every two or more receptions of the synchronization signal via the network, a communication timing so that a frequency of the communication timing is reduced from a transmission frequency of the synchronization signal;
perform, in accordance with the communication timing periodically determined with the reduced frequency, data exchange with the time master including transmission of a response signal to the synchronization signal;
acquire an offset of the local clock with respect to the time master based on a result of the data exchange;
correct the local clock in accordance with the offset; and
control a machine based on the corrected local clock.

5. The control system according to claim 1, wherein the circuitry is configured to stop transmitting the response signal to the time master in response to determining that the response signal is not transmitted within a predetermined time from a reception time of the synchronization signal.

6. The control system according to claim 1, wherein the circuitry is further configured to:
exchange, with an application, control data having a designation of a periodic timing for periodic communication via the network that is non-periodic; and
control the machine using the control data at the designated periodic timing based on the local clock.

7. The control system according to claim 1, wherein the circuitry is further configured to additionally correct the local clock at an additional correction timing different from the communication timing, based on the offset acquired in the data exchange.

8. The control system according to claim 7, wherein the circuitry is configured to:
periodically determine the communication timing at a first frequency to gradually decrease the offset;
switch the frequency of the communication timing to a second frequency lower than the first frequency in response to determining that the offset decreases so that a predetermined condition is satisfied, and
additionally correct the local clock at the additional correction timing based on the offset that satisfies the predetermined condition after the frequency of the communication timing is switched from the first frequency to the second frequency.

9. The control system according to claim 8, wherein the predetermined condition is that a difference in the offset between the determined communication timing and the previously determined communication timing is less than a predetermined threshold.

10. The control system according to claim 8, wherein the circuitry is configured to determine the additional correction timing in response to receiving the synchronization signal that does not correspond to the communication timing.

11. The control system according to claim 8, wherein the circuitry is configured to:
set the additional correction timing based on the offset that satisfies the predetermined condition and a predetermined allowable offset; and
additionally correct the local clock at the set additional correction timing.

12. The control system according to claim 11, wherein the circuitry is configured to:
calculate a timing at which the offset exceeds the predetermined allowable offset based on the offset that satisfies the predetermined condition and the first frequency; and
set the additional correction timing before the calculated timing.

13. The control system according to claim 1, wherein the circuitry is configured to:
periodically determine the communication timing at a first frequency to gradually decrease the offset;
set a second frequency lower than the first frequency based on the offset and a predetermined allowable offset in response to determining that the offset decreases so that a predetermined condition is satisfied; and
switch the frequency of the communication timing from the first frequency to the second frequency.

14. The control system according to claim 13, wherein the circuitry is configured to:
calculate a length of time for the offset to exceed the predetermined allowable offset based on the offset that satisfies the predetermined condition and the first frequency; and
set the second frequency so that a period corresponding to the second frequency is shorter than the calculated length of time.

15. The control system according to claim 1, wherein the circuitry is configured to:
periodically determine the communication timing at a first frequency equal to the transmission frequency of the synchronization signal to gradually decrease the offset,
switch the frequency of the communication timing to a second frequency lower than the first frequency in response to determining that the offset decreases so that a predetermined condition is satisfied, and
wherein the time master is configured to switch the transmission frequency of the synchronization signal to the second frequency in response to determining that the frequency of the communication timing is switched to the second frequency.

16. The control system according to claim 15, wherein the predetermined condition is that a difference in the offset between the determined communication timing and the previously determined communication timing is less than a predetermined threshold.

17. The control system according to claim 1, further comprising second circuitry connected to the time master via the network,
wherein the second circuitry comprises a second local clock and is configured to:
periodically determine, for every two or more receptions of the synchronization signal via the network, a second communication timing that is different from the communication timing so that a frequency of the second communication timing is reduced from the transmission frequency of the synchronization signal;
periodically perform, in accordance with the second communication timing periodically determined with the reduced frequency, second data exchange with the time master including transmission of a second response signal to the synchronization signal;
acquire a second offset of the second local clock with respect to the time master based on a result of the second data exchange;
correct the second local clock in accordance with the second offset; and
control a second machine based on the corrected local clock.

18. A communication terminal communicable with a time master via a network and communicable with control circuitry,
wherein the time master is configured to periodically transmit a synchronization signal for time synchronization via the network;
wherein the control circuitry comprises a local clock and is configured to:
receive the synchronization signal via the communication terminal;
transmit, in response to receiving the synchronization signal, a response signal to the communication terminal for a data exchange;
acquire an offset of the local clock based on a result of the data exchange; and
correct the local clock in accordance with the offset, and
wherein the communication terminal is configured to:
periodically determine, for every two or more receptions of the synchronization signal via the network, a communication timing so that a frequency of the communication timing is reduced from a transmission frequency of the synchronization signal;
receive the response signal from the control circuitry;
transmit, to the time master, the received response signal that corresponds to the determined communication timing so that the data exchange is performed;
block the response signal that does not correspond to the communication timing, thereby preventing completion of the data exchange.

19. The communication terminal according to claim 18 configured to determine the communication timing based on identification information included in the synchronization signal.

20. A communication method comprising:
receiving a synchronization signal periodically transmitted from a time master via a network;
periodically determining, for every two or more receptions of the synchronization signal via the network, a communication timing so that a frequency of the communication timing is reduced from a transmission frequency of the synchronization signal;
periodically performing, in accordance with the communication timing periodically determined with the reduced frequency, data exchange with the time master including transmission of a response signal to the synchronization signal;
acquiring an offset of a local clock with respect to the time master based on a result of the data exchange;
correcting the local clock in accordance with the offset.
